(19) United States
(12) Patent Application Publication
(10) Pub. No.: US 2022/0163714 A1
(43) Pub. Date: May 26, 2022

(54) LASER-EXCITED TAPERED CRYSTAL-PHOSPHOR ROD

(71) Applicant: Optonomous Technologies, Inc., Agoura Hills, CA (US)

(72) Inventor: Kenneth Li, Agoura Hills, CA (US)

(21) Appl. No.: 17/527,089

(22) Filed: Nov. 15, 2021

Related U.S. Application Data
(60) Provisional application No. 63/116,781, filed on Nov. 20, 2020.

(51) Int. Cl. F21V 8/00; H01S 3/04; H01S 3/16

(52) U.S. Cl. CPC G02B 6/0003; H01S 3/163; H01S 3/0405

(57) ABSTRACT

A laser-excited phosphor system with increased light-output efficiency, the system including: a crystal-phosphor rod that includes an input-end face and an opposite end and a tapered section having a tapered longitudinal cross section that is larger nearest the input-end face than at the opposite end. Some embodiments further include an internally reflective waveguide around the crystal-phosphor rod, the crystal-phosphor rod includes a non-tapered section between the input-end face and the tapered section, and a heatsink contacting the non-tapered section; a CPC located to collect light from the waveguide and the crystal-phosphor rod and configured to output a focused light beam; a wavelength-selective filter located adjacent the input-end face of the crystal-phosphor rod; a laser system that emits pump light through the wavelength-selective filter into the crystal-phosphor rod; and projection optics.

### CROSS-REFERENCE TO RELATED APPLICATIONS

This application claims priority benefit, under 35 U.S.C. § 119(e), of U.S. Provisional Patent Application 63/116,781 titled “Laser-Excited Tapered Crystal-Phosphor Rod,” by Kenneth Li, filed Nov. 20, 2020, which is incorporated herein by reference in its entirety.

This application is related to:
U.S. Provisional Patent Application 62/972,553 titled “Scanner System Allowing Change in Path Length with Constant Input and Output Optical Axes,” by Kenneth Li, filed Feb. 10, 2020;
U.S. Provisional Patent Application 63/106,813 titled “Scanner System with Variable Path Length for Microscope Focusing,” by Kenneth Li, filed Oct. 28, 2020;
U.S. Provisional Patent Application 63/125,357 titled “Scanner System with Variable Path Length for Microscope Focusing,” by Kenneth Li, filed Dec. 14, 2020;
U.S. Provisional Patent Application 63/079,984 titled “LASER PHOSPHOR ILLUMINATION SYSTEM USING STATIONARY PHOSPHOR FIXTURE,” filed Sep. 17, 2020 by Kenneth Li et al.;
U.S. Provisional Patent Application 62/967,321 titled “LASER PHOSPHOR ILLUMINATION SYSTEM USING STATIONARY PHOSPHOR FIXTURE,” filed Jan. 29, 2020 by Kenneth Li;
U.S. Provisional Patent Application 62/957,036 titled “LASER PHOSPHOR ILLUMINATION SYSTEM USING STATIONARY PHOSPHOR FIXTURE,” filed Jan. 3, 2020 by Kenneth Li;
U.S. Provisional Patent Application 62/931,163 titled “LASER PHOSPHOR ILLUMINATION SYSTEM USING STATIONARY PHOSPHOR FIXTURE,” filed Nov. 5, 2019 by Kenneth Li;
P.C.T. Patent Application No. PCT/US2020/037669, filed Jun. 14, 2020 by Kenneth Li et al., titled “HYBRID LED/LASER LIGHT SOURCE FOR SMART HEADLIGHT APPLICATIONS” (published Dec. 24, 2020 as WO 2020/257091);
U.S. Provisional Patent Application 62/862,549 titled “ENHANCEMENT OF LED INTENSITY PROFILE USING LASER EXCITATION,” filed Jun. 17, 2019 by Kenneth Li;
U.S. Provisional Patent Application 62/874,943 titled “ENHANCEMENT OF LED INTENSITY PROFILE USING LASER EXCITATION,” filed Jul. 16, 2019 by Kenneth Li;
U.S. Provisional Patent Application 62/938,863 titled “DUAL LIGHT SOURCE FOR SMART HEADLIGHT APPLICATIONS,” filed Nov. 21, 2019 by Y. P. Chang et al.;
U.S. Provisional Patent Application 62/954,337 titled “HYBRID LED/LASER LIGHT SOURCE FOR SMART HEADLIGHT APPLICATIONS,” filed Dec. 27, 2019 by Kenneth Li;
P.C.T. Patent Application No. PCT/US2020/034447, filed May 24, 2020 by Y. P. Chang et al., titled “LiDAR INTEGRATED WITH SMART HEADLIGHT AND METHOD” (published Dec. 3, 2020 as WO 2020/243038);
U.S. Provisional Patent Application No. 62/853,538, filed May 28, 2019 by Y. P. Chang et al., titled “LIDAR Integrated With Smart Headlight Using a Single DMD”;
U.S. Provisional Patent Application No. 62/857,662, filed Jun. 5, 2019 by Chun-Nien Liu et al., titled “Scheme of LIDAR-Embedded Smart Laser Headlight for Autonomous Driving”;
U.S. Provisional Patent Application No. 62/950,080, filed Dec. 18, 2019 by Kenneth Li, titled “Integrated LIDAR and Smart Headlight using a Single MEMS Mirror”;
PCT Patent Application PCT/US2019/037231 titled “ILLUMINATION SYSTEM WITH HIGH INTENSITY OUTPUT MECHANISM AND METHOD OF OPERATION THEREOF,” filed Jun. 14, 2019 by Y. P. Chang et al. (published Jan. 16, 2020 as WO 2020/013952);
U.S. patent application Ser. No. 16/509,085 titled “ILLUMINATION SYSTEM WITH CRYSTAL PHOSPHOR MECHANISM AND METHOD OF OPERATION THEREOF,” filed Jul. 11, 2019 by Y. P. Chang et al. (published Jan. 23, 2020 as US 2020/0026169);
U.S. Pat. No. 10,754,236 titled “ILLUMINATION SYSTEM WITH HIGH INTENSITY PROJECTION MECHANISM AND METHOD OF OPERATION THEREOF,” issued Aug. 25, 2020 to Y. P. Chang et al.;
U.S. Provisional Patent Application 62/837,077 titled “LASER EXCITED CRYSTAL PHOSPHOR SPHERE LIGHT SOURCE,” filed Apr. 22, 2019 by Kenneth Li et al.;
U.S. Provisional Patent Application 62/853,538 titled “LIDAR INTEGRATED WITH SMART HEADLIGHT USING A SINGLE DMD,” filed May 28, 2019 by Y. P. Chang et al.;
U.S. Provisional Patent Application 62/856,518 titled “VERTICAL CAVITY SURFACE EMITTING LASER USING DICHROIC REFLECTORS,” filed Jul. 8, 2019 by Kenneth Li et al.;
U.S. Provisional Patent Application 62/871,498 titled “LASER-EXCITED PHOSPHOR LIGHT SOURCE AND METHOD WITH LIGHT RECYCLING,” filed Jul. 8, 2019 by Kenneth Li;
U.S. Provisional Patent Application 62/857,662 titled “SCHEME OF LIDAR-EMBEDDED SMART LASER HEADLIGHT FOR AUTONOMOUS DRIVING,” filed Jun. 5, 2019 by Chun-Nien Liu et al.;
U.S. Provisional Patent Application 62/873,171 titled “SPECKLE REDUCTION USING MOVING MIRRORS AND RETRO-REFLECTORS,” filed Jul. 11, 2019 by Kenneth Li;
U.S. Provisional Patent Application 62/881,927 titled “SYSTEM AND METHOD TO INCREASE BRIGHTNESS OF DIFFUSED LIGHT WITH FOCUSED RECYCLING,” filed Aug. 1, 2019 by Kenneth Li;
U.S. Provisional Patent Application 62/895,367 titled “INCREASED BRIGHTNESS OF DIFFUSED LIGHT WITH FOCUSED RECYCLING,” filed Sep. 3, 2019 by Kenneth Li;
U.S. Provisional Patent Application 62/903,620 titled “RGB LASER LIGHT SOURCE FOR PROJECTION DISPLAYS,” filed Sep. 20, 2019 by Lion Wang et al.; and
PCT Patent Application No. PCT/US2020/035492, filed Jun. 1, 2020 by Kenneth Li et al., titled “VERTICAL-CAVITY SURFACE-EMITTING LASER USING DICHROIC REFLECTORS” (published Dec. 10, 2020 as WO 2020/247291);
   each of which is incorporated herein by reference in its entirety.

### FIELD OF THE INVENTION

This invention relates to the field of light sources, and more specifically to a method and light source that includes lasers, laser-pumped crystal-phosphor light sources optionally including heat sinks and/or internally reflecting waveguides, and compound parabolic reflectors, combined together to provide stationary light output with improved light-beam quality, higher beam intensity, and/or improved etendue.

### BACKGROUND OF THE INVENTION

In laser-excited-phosphor systems, crystal phosphor would be an attractive material for use in such systems, as compared to systems that use organic-glue-based phosphor, or other non-transparent ceramic phosphor, or glass phosphor. The transparent property of the crystal phosphor allows the use of a larger volume of emission material for better heat sinking, allowing higher-power operations. The major disadvantage is the high refractive index of the crystal-phosphor material, which results in a small critical angle for light approaching the surface of the crystal phosphor rod from the inside. The light emitted by the phosphor inside the crystal phosphor will thus have a small solid angle for emission to the outside of the crystal phosphor rod. Such light emitted by the phosphor inside the crystal phosphor rod is mostly trapped inside the rod by total internal reflection, as shown in FIG. 1A.

FIG. 1A is a side-view cross-sectional block diagram of a conventional laser-excited crystal-phosphor rod system 101 having a non-tapered crystal-phosphor rod 120, with much of the wavelength-converted phosphor-emitted light undesirably trapped inside the rod 120 by total internal reflection. In some embodiments, system 101 includes a rectangular or cylindrical (or other shape, e.g., having parallel top face 123 and bottom face 124, and parallel front side face 125 and back side face 126) crystal-phosphor rod 120 that receives laser light 111 from a laser system 110, and the phosphor in crystal-phosphor rod 120 (which phosphor is located throughout rod 120) absorbs the shorter-wavelength laser light 111 (e.g., in some embodiments, blue light) and emits longer-wavelength light 131 at random angles. As an example, FIG. 1A shows a small circle around just one exemplary phosphor particle 127 or molecule that absorbs the incoming blue laser light 111 and emits a longer-wavelength light 131 (such as green, yellow, orange and/or red wavelengths); actually rod 120 is filled with such phosphor particles or molecules, each of which emits its longer-wavelength light 131 at a relatively random angle, which most often reflects repeatedly (e.g., at points 132A, 132B, 132C, 132D, 132E and 132F, etc.) by total internal reflections caused when emitted longer-wavelength light impinges on the surface (e.g., top surface 123 and bottom surface 124, front side surface 125 facing toward the viewer and back side surface 126, and right-hand end surface 122 and input surface 121) at a shallow angle relative to the surface of the rod—an angle that is farther from the normal (perpendicular to the surface plane) vector than the critical angle. Only a small percentage of the emitted light from the phosphor is within the critical angle (i.e., closer to the normal vector to the surface than the critical angle) and can be collected as the output of the system (either within the critical angle to the sides 123, 124, 125 and 126 of rod 120 or within the critical angle to end 122 of rod 120, as shown in FIG. 1B).

FIG. 1B is a side-view cross-sectional block diagram of conventional laser-excited crystal-phosphor rod system 101 showing that some of the wavelength-converted phosphor-emitted light is emitted from top side 123 and end 122 of rod 120 by steep angles of incidence (angles close to the surface normal vector); note that other corresponding steep-angled light (not shown here, for figure simplicity) is emitted from bottom side 124, front 125 and back 126 sides, and possibly from input side 121 of rod 120. For a refractive index of n=1.82, the critical angle is 33.3°. The total output from all surfaces (surfaces 121, 122, 123, 124, 125 and 126, in the rectangular solid shown) is about 36%, with only 9% from the right-hand-end output surface 122. With all other surfaces being reflective, there will be some increase in output. As a result, it becomes critical to find a way to increase the output efficiency of the system. One common method is to make the output surface with a photonic structure such that the output coupling can be increased. On the other hand, such photonic structures are difficult and costly to make consistently, with consistent results. The present invention overcomes this difficulty and uses a non-photonic structure achieving the higher output efficiency.

U.S. Pat. No. 10,386,559 issued to Hikmet, et al. on Aug. 20, 2019 with the title “Light emitting device comprising wavelength converter” and is incorporated herein by reference in its entirety. U.S. Pat. No. 10,386,559 describes a light-emitting device that includes a light source having a light exit surface, a wavelength converter configured to convert light from a first wavelength to a second wavelength, the wavelength converter having a light exit surface and a light entrance surface, a heat sink and an optical-coupling element arranged in thermal connection with the heat sink and the wavelength converter, wherein the optical-coupling element is selected to have a refractive index lower than a refractive index of said wavelength converter. The optical coupling element will allow for an efficient heat transfer from the wavelength converter to the heat sink while avoiding loss of light from unwanted surfaces.

Examples of inorganic phosphor materials include cerium (Ce) doped YAG (Y₃Al₅O₁₂) or LuAG (Lu₃Al₅O₁₂). Ce-doped YAG emits yellowish light, whereas Ce-doped LuAG emits yellow-greenish light. Examples of other inorganic phosphors materials that emit red light may include ECAS and BSSN; ECAS being Ca₁₋ₓAl_{y}SiN₃:Euₓ, wherein 0<x<1, preferably 0<x<0.2; and BSSN being Ba_{2-x-z}MₓSi_{5-y}Al_{y}N_{8-y}O_{y}:Eu_{z}, wherein M represents Sr or Ca, 0<x<1, 0<y<4, and 0.0005≤z<0.05, and preferably 0≤x<0.2. According to some embodiments of the present invention, the crystal rod's luminescent material is essentially made of material selected from the group comprising:

(M<I>_{1-x-y}M<II>ₓM<III>_{y})₃(M<IV>_{1-z}M<V>_{z})₅O₁₂—where M<I> is selected from the group comprising Y, Lu or mixtures thereof, M<II> is selected from the group comprising Gd, La, Yb or mixtures thereof, M<III> is selected from the group comprising Tb, Pr, Ce, Er, Nd, Eu or mixtures thereof, M<IV> is Al, M<V> is selected from the group comprising Ga, Sc or mixtures thereof, and 0<x≤1, 0<y≤0.1, 0<z≤1,

(M<I>_{1-x-y}M<II>ₓM<III>_{y})₂O₃—where M<I> is selected from the group comprising Y, Lu or mixtures thereof, M<II> is selected from the group comprising Gd, La, Yb or mixtures thereof, M<III> is selected from the group comprising Tb, Pr, Ce, Er, Nd, Eu, Bi, Sb or mixtures thereof, and 0<x≤1, 0≤y<0.1,

(M<I>_{1-x-y}M<II>ₓM<III>_{y})S_{1-z}Se_{z}—where M<I> is selected from the group comprising Ca, Sr, Mg, Ba or mixtures thereof, M<II> is selected from the group comprising Ce, Eu, Mn, Tb, Sm, Pr, Sb, Sn or mixtures thereof, M<III> is selected from the group comprising K, Na, Li, Rb, Zn or mixtures thereof, and 0≤x<0.01, 0≤y<0.05, 0<z≤1,

(M<I>_{1-x-y}M<II>ₓM<III>_{y})O—where M<I> is selected from the group comprising Ca, Sr, Mg, Ba or mixtures thereof, M<II> is selected from the group comprising Ce, Eu, Mn, Tb, Sm, Pr or mixtures thereof, M<III> is selected from the group comprising K, Na, Li, Rb, Zn or mixtures thereof, and 0≤x<0.1, 0≤y<0.1,

(M<I>₂₋ₓM<II>ₓM<III>₂)O₇—where M<I> is selected from the group comprising La, Y, Gd, Lu, Ba, Sr or mixtures thereof, M<II> is selected from the group comprising Eu, Tb, Pr, Ce, Nd, Sm, Tm or mixtures thereof, M<III> is selected from the group comprising Hf, Zr, Ti, Ta, Nb or mixtures thereof, and 0<=x<=1, and/or

(M<I>₁₋ₓM<II>ₓM<III>_{1-y}M<IV>_{y})O₃—where M<I> is selected from the group comprising Ba, Sr, Ca, La, Y, Gd, Lu or mixtures thereof, M<II> is selected from the group comprising Eu, Tb, Pr, Ce, Nd, Sm, Tm or mixtures thereof, M<III> is selected from the group comprising Hf; Zr, Ti, Ta, Nb or mixtures thereof, and M<IV> is selected from the group comprising Al, Ga, Sc, Si or mixtures thereof, and 0<x<0.1, 0<y<0.1, or mixtures thereof.

Particularly suitable luminescent materials are Ce-doped yttrium aluminum garnet (YAG, Y3AI5O12) and lutetium-aluminum garnet (LuAG).

A journal article by Dick K. G. de Boer, Dominique Bruls, and Henri Jagt titled “High lumen density sources based on LED-pumped phosphor rods: opportunities for performance improvement” (Proc. SPIE 10378, Sixteenth International Conference on Solid State Lighting and LED-based Illumination Systems, 103780M (6 Sep. 2017)) describes “for high brightness applications with limited étendue, e.g. front projection, only very modest luminance values in the beam can be achieved with LEDs compared to systems based on discharge lamps or lasers. With dedicated architectures, phosphor-converted green LEDs for projection may achieve luminance values up to 200-300 Mnit. In this paper we report on the progress made in the development of light engines based on an elongated luminescent concentrator pumped by blue LEDs. This concept has recently been introduced to the market as ColorSpark High Lumen Density LED technology. These sources outperform the maximum brightness of LEDs by multiple factors. In LED front projection, green LEDs are the main limiting factor. With our green modules, we now have achieved peak luminance values of 2 Gnit, enabling LED-based projection systems with over 4000 ANSI lm. Extension of this concept to yellow and red light sources is presented. The light source efficiency has been increased considerably, reaching 45-60 lm/W for green under practical application conditions. The module architecture, beam shaping, and performance characteristics are reviewed, as well as system aspects. The performance increase, spectral range extensions, beam-shaping flexibility, and cost reductions realized with the new module architecture enable a breakthrough in LED-based projection systems and in a wide variety of other high brightness applications.”

What is needed is an improved system having a better laser-excited crystal phosphor rod, wherein the system is smaller, lighter, easier to cool and more efficient in extracting wavelength-converted light than existing systems.

### SUMMARY OF THE INVENTION

In some embodiments, the present invention provides an apparatus that includes: a first crystal-phosphor rod that includes an input-end face and an opposite end and a tapered section having one or more side surfaces of a tapered longitudinal cross section that is larger nearest the input-end face than at the opposite end. In some embodiments, the first crystal-phosphor rod further includes a non-tapered section between the input-end face and the tapered section. Some embodiments further include an internally reflective waveguide, wherein the first crystal-phosphor rod is located within the waveguide; and a heat sink surrounding at least a portion of the internally reflective waveguide, wherein the first crystal-phosphor rod further includes a non-tapered section between the input-end face and the tapered section, and wherein the non-tapered section is in thermal contact with the heat sink.

In some embodiments, the first crystal-phosphor rod has a rectangular transverse cross-sectional shape, wherein the first crystal-phosphor rod includes a phosphor that absorbs laser pump light having one or more wavelengths between 300 nm and 500 nm and emits phosphor-emitted light have one or more wavelengths longer than 500 nm, wherein the input-end face is coated with a wavelength-selective coating that passes a majority of the pump light and reflects a majority of the phosphor-emitted light.

Some embodiments further include an internally reflective waveguide, wherein the first crystal-phosphor rod is located within the waveguide; a heat sink surrounding at least a portion of the internally reflective waveguide, wherein the first crystal-phosphor rod further includes a non-tapered section between the input-end face and the tapered section, and wherein the non-tapered section is in thermal contact with the heat sink; a compound parabolic concentrator (CPC) located to collect light from the waveguide and the first crystal-phosphor rod and to output a focused light beam; a wavelength-selective filter located adjacent the input-end face of the first crystal-phosphor rod; a laser system having at least one laser that emits pump light through the wavelength-selective filter into the first crystal-phosphor rod; and projection optics for stage lighting, wherein light from the focused light beam is used for illumination for the stage lighting.

In some embodiments, the present invention provides a method that includes: receiving laser light into a first crystal-phosphor rod that includes an input-end face and an opposite end, and a tapered section having one or more side surfaces of a tapered longitudinal cross section that is larger nearest the input-end face than at the opposite end; and collecting and concentrating phosphor-emitted light from the one or more side surfaces of the first crystal-phosphor rod into an output light beam.

### BRIEF DESCRIPTION OF THE DRAWINGS

FIG. 1A is a side-view cross-sectional block diagram of a conventional laser-excited crystal-phosphor rod system 101 having a non-tapered crystal-phosphor rod 120, with much of the wavelength-converted phosphor-emitted light undesirably trapped inside the rod 120 by total internal reflection.

FIG. 1B is a side-view cross-sectional block diagram of conventional laser-excited crystal-phosphor rod system 101 with some of the wavelength-converted phosphor-emitted light emitted from side 123 and from an end 122 of the rod 120, by steep angles of incidence.

FIG. 2 is a side-view cross-sectional block diagram of a laser-pumped crystal-phosphor light source 201 that uses a tapered crystal-phosphor rod 220, according to some embodiments of the present invention.

FIG. 3A is a side-view cross-sectional block diagram of a laser-pumped crystal-phosphor light source 301, according to some embodiments of the present invention.

FIG. 3B is a side-view cross-sectional block diagram of a laser-pumped crystal-phosphor light source 302, according to some embodiments of the present invention.

FIG. 3C is a side-view cross-sectional block diagram of a laser-pumped crystal-phosphor light source 303, according to some embodiments of the present invention.

FIG. 4A is a perspective-view block diagram of a flat-end tapered crystal-phosphor rod 401, according to some embodiments of the present invention.

FIG. 4B is a perspective-view block diagram of a pointed-end tapered crystal-phosphor rod 402, according to some embodiments of the present invention.

FIG. 4C is a perspective-view block diagram of a wedge-shaped tapered crystal-phosphor rod 403, according to some embodiments of the present invention.

FIG. 5 is a side-view cross-sectional block diagram of a laser-pumped crystal-phosphor system 501 having a one-dimensional or two-dimensional array of tapered crystal-phosphor rods 520, according to some embodiments of the present invention.

FIG. 6 is a block diagram of a system 601 having one or more laser-pumped crystal-phosphor light sources 660, according to some embodiments of the present invention.

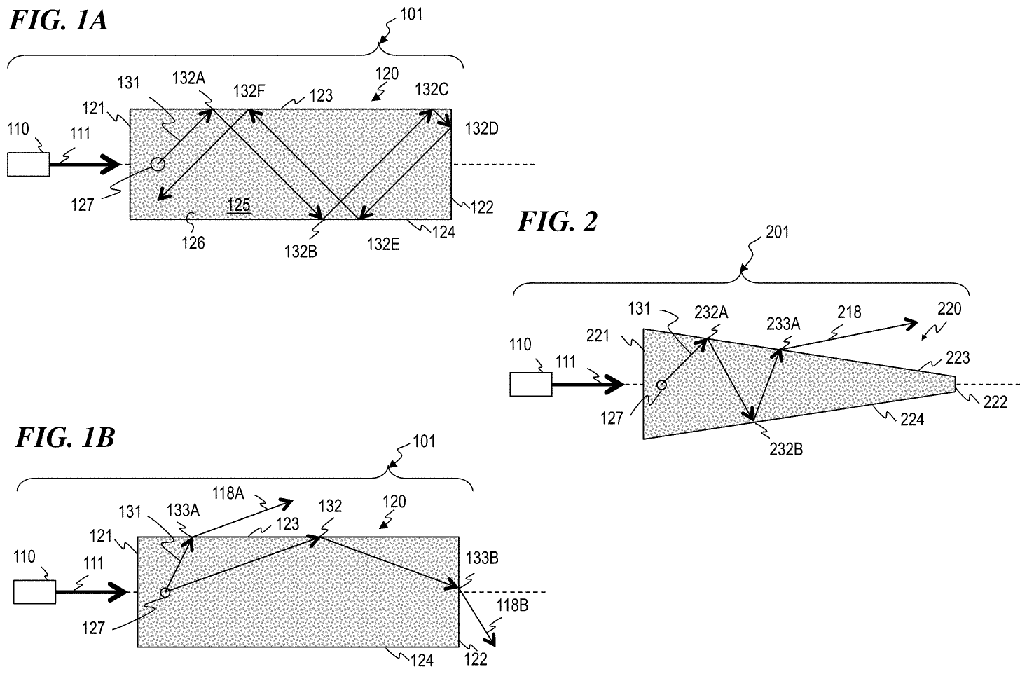

### DESCRIPTION OF PREFERRED EMBODIMENTS OF PART A OF THE INVENTION

Although the following detailed description contains many specifics for the purpose of illustration, a person of ordinary skill in the art will appreciate that many variations and alterations to the following details are within the scope of the invention. Specific examples are used to illustrate particular embodiments; however, the invention described in the claims is not intended to be limited to only these examples, but rather includes the full scope of the attached claims. Accordingly, the following preferred embodiments of the invention are set forth without any loss of generality to, and without imposing limitations upon the claimed invention. Further, in the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The embodiments shown in the Figures and described here may include features that are not included in all specific embodiments. A particular embodiment may include only a subset of all of the features described, or a particular embodiment may include all of the features described.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Certain marks referenced herein may be common-law or registered trademarks of third parties affiliated or unaffiliated with the applicant or the assignee. Use of these marks is for providing an enabling disclosure by way of example and shall not be construed to limit the scope of the claimed subject matter to material associated with such marks.

FIG. 2 is a side-view cross-sectional block diagram of a laser-pumped crystal-phosphor light source 201 that uses a tapered crystal-phosphor rod 220, according to some embodiments of the present invention. In some embodiments, a laser system 110 includes one or more lasers that generate laser light 111 directed into input-end face 221 of tapered crystal-phosphor rod 220, which has top face 223 and bottom face 224 that are tapered toward one another from a larger input-end face 221 to a smaller opposite-end face 222. The dimensions of the small output end 222 have a limit of being a point, but in some embodiments the size of end 222 is limited by practical fabrication processes. Emitted light 131 is emitted at random angles from each laser-light-excited phosphor molecule or particle 127, and if the light is at a larger angle relative to the surface normal vector (a shallower angle relative to the plane of the surface) than the critical angle, it is reflected back into rod 220 by total internal reflection (for example, at locations 232A and 232B on the tapered side walls 223 and 224). The incidence angle of the light will become smaller (closer to the normal vector to the surface of the rod) after each reflection, and will eventually be less than the critical angle. At this point (for example, point 233A after one or more internal reflections 232A and/or 232B), a large majority of the emitted light 131 from each phosphor particle or molecule 127 will exit top side 223 and bottom side 224 (via other phosphor-emitted rays not shown in this figure) of the tapered crystal-phosphor rod, and perhaps some small amount of light will exit out the small end 222 of tapered rod 220 (via other phosphor-emitted rays, not shown), to become the output light 218 of system 201. Eventually, all light of ray 131 and other phosphor-emitted rays that are not absorbed by imperfections in rod 220 will exit the tapered crystal-phosphor rod 220 as output light, of which only one ray 218 is shown here.

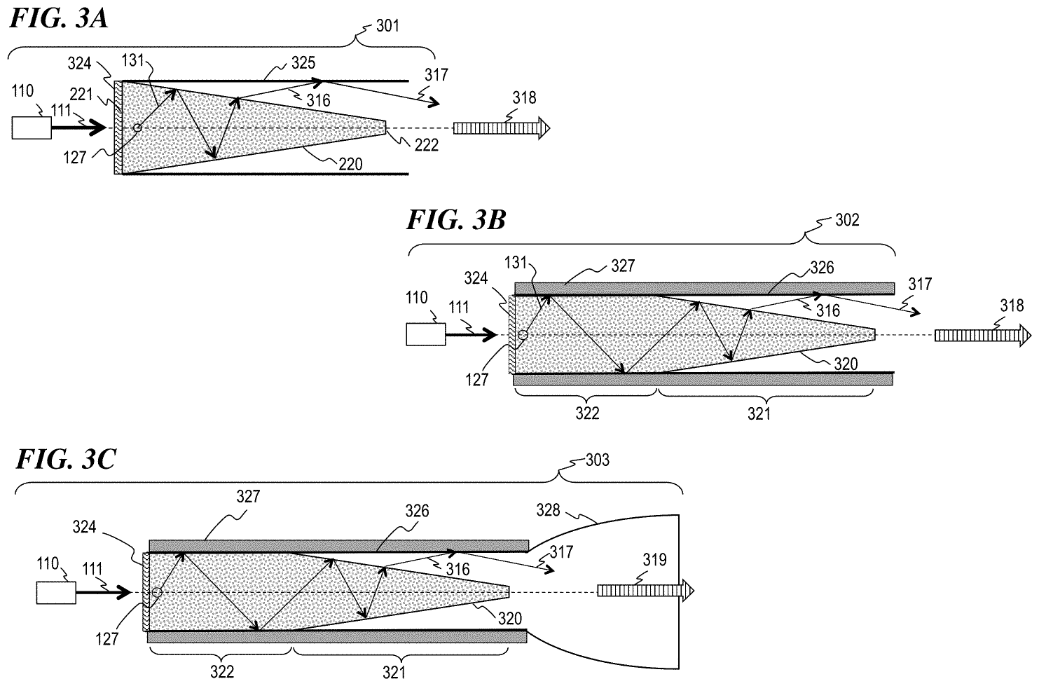

FIG. 3A is a side-view cross-sectional block diagram of a laser-pumped crystal-phosphor light source 301, in which tapered crystal-phosphor rod 220 is housed inside an internally reflective waveguide 325 such that the output 316 from tapered crystal-phosphor rod 220 is directed to the output light 318 of the waveguide 325, either as light 316 directly from tapered rod 220, or as reflected light 317 from reflective waveguide 325. In some embodiments, the input end 221 of the crystal-phosphor rod 220 is coated with a blue-transmissive, yellow-reflective coating 324 that transmits short-wavelength laser light 111 from laser 110 into tapered crystal-phosphor rod 220 and reflects longer-wavelength phosphor-emitted light such that the wavelength-converted output from the phosphors (e.g., molecule 127) that initially gets randomly emitted leftward in crystal-phosphor rod 220 is reflected by coating 324 rightward and directed towards top side 223 and bottom side 224 and opposite-end face 222 of light source 301.

FIG. 3B is a side-view cross-sectional block diagram of a laser-pumped crystal-phosphor light source 302, according to some embodiments of the present invention. In some embodiments, to facilitate heat sinking and ease of assembly, a straight section 322 (wherein the top and bottom faces are parallel) is added to the tapered section 321 of crystal-phosphor rod 320, as shown in FIG. 3B. In some embodiments, tapered section 321 and straight section 322 are formed from a single piece of crystal rod, while in other embodiments, they are formed from two pieces of crystal rod and adhered to one another using an index-matched adhesive or other joining method. Most of the laser light 111 from laser 110 is transmitted through a blue-transmissive, yellow-reflective coating 324 and absorbed by straight section 322, and the heat generated in straight section 322 is dissipated by heat sink 327. The inner surface of heat sink 327 is coated with a highly reflective coating 326 in direct contact with straight section 322 such that light emitted from each phosphor molecule or particle 127 is reflected toward the tapered section 321, and the heat generated in straight section 322 is conducted to heat sink 327 and dissipated by radiation, convection or conduction (passive, fan-cooled or liquid-cooled heat sinking). At the same time, the emitted light 131 transmits through tapered top and bottom sides of tapered section 322 of crystal-phosphor rod 320 as emitted light 316, with little loss. In some embodiments, output light 316 from tapered crystal-phosphor rod 220 is directed to the output light 318 of the waveguide 325, either as light 316 directly from tapered rod 220, or as reflected light 317.

FIG. 3C is a side-view cross-sectional block diagram of a laser-pumped crystal-phosphor light source 303, according to some embodiments of the present invention. In some embodiments, light source 303 is substantially the same as light source 302, but with the addition of CPC 328 (compound parabolic concentrator) at the right-hand output end. In some embodiments of each of the embodiments described herein, in order that the light output has a smaller angle for ease of coupling, a CPC 328 is added at the output end of the device to provide a smaller output divergence angle with a larger output area such that the brightness is conserved—for example, as shown in FIG. 3C.

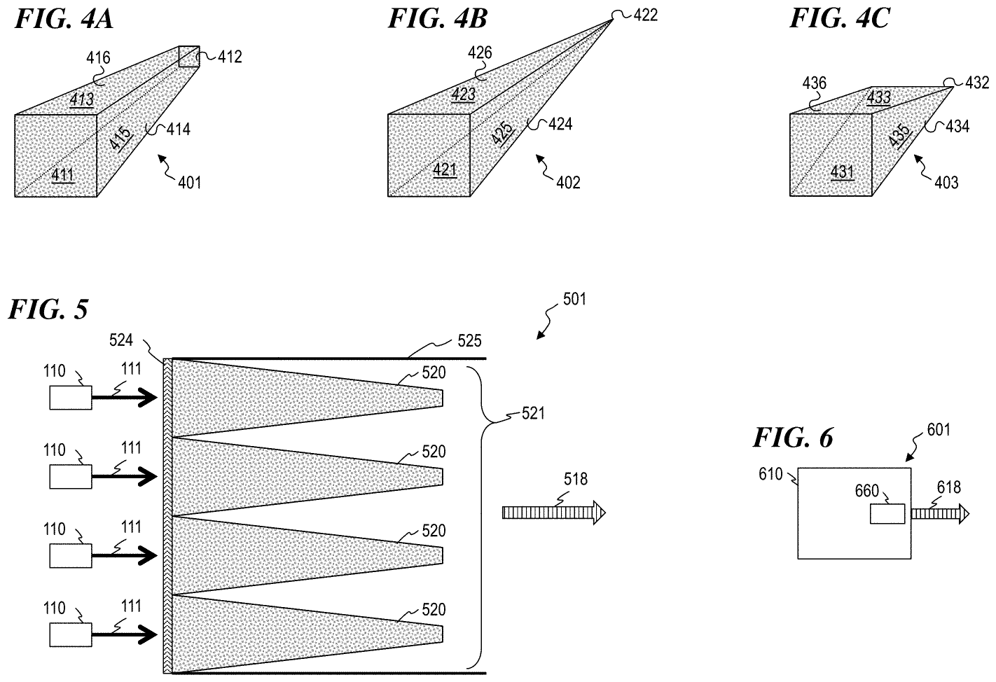

FIG. 4A is a perspective-view block diagram of a flat-end tapered crystal-phosphor rod 401, according to some embodiments of the present invention. In some embodiments, flat-end tapered crystal-phosphor rod 401 has a rectangular cross section shape (e.g., in some embodiments, a square cross section), an entry surface 411, top and bottom surfaces 413 and 414, respectively, that taper towards each other from entry surface end 411 to distal-end surface 412, and left-hand and right-hand surfaces 416 and 415 that also taper towards each other from entry surface end 411 to distal-end surface 412. When crystal-phosphor rod 401 is used in light source 301, light source 302, or light source 303, phosphor-emitted light that successively reflects between top and bottom surfaces 413 and 414, respectively, reflects (due to total-internal reflection) at successively steeper angles until the light escapes either the top surface 413 or bottom surface 414, and then is reflected and guided by the external wave guide reflector surface 325 or 326 and/or CPC 328 to form output light 318 or 319. Similarly, phosphor-emitted light that successively reflects between left and right surfaces 416 and 415, respectively, reflects (due to total-internal reflection) at successively steeper angles until the light escapes either the left-hand surface 416 or right-hand surface 415. Some phosphor-emitted light that successively reflects (clockwise) between left-hand, top, right-hand and bottom surfaces 416, 413, 415 and 414, respectively, reflects (due to total-internal reflection) at successively steeper angles until the light escapes one of the left-hand, top, right-hand or bottom surfaces 416, 413, 415 and 414. Some phosphor-emitted light that successively reflects (counter-clockwise) between left-hand, bottom, right-hand and top surfaces 416, 414, 415 and 413, respectively, reflects (due to total-internal reflection) at successively steeper angles until the light escapes one of the left-hand, bottom, right-hand or top surfaces 416, 414, 415 and 413. A small amount of phosphor-emitted light exits through distal-end surface 412.

FIG. 4B is a perspective-view block diagram of a pointed-end tapered crystal-phosphor rod 402, according to some embodiments of the present invention. In some embodiments, pointed-end tapered crystal-phosphor rod 402 has a rectangular cross section shape (e.g., in some embodiments, a square cross section), an entry surface 421, top and bottom surfaces 423 and 424, respectively, that taper towards each other from entry surface end 421 to distal-end point 422, and left-hand and right-hand surfaces 426 and 425 that also taper towards each other from entry surface end 421 to distal-end point 422. Light reflects and exits crystal-phosphor rod 402 in a manner similar to crystal-phosphor rod 401.

FIG. 4C is a perspective-view block diagram of a wedge-shaped tapered crystal-phosphor rod 403, according to some embodiments of the present invention. In some embodiments, wedge-shaped tapered crystal-phosphor rod 403 has a rectangular cross section shape, an entry surface 431, top and bottom surfaces 433 and 434, respectively, that taper towards each other from entry surface end 431 to distal-end 432, and left-hand and right-hand surfaces 436 and 435 that remain parallel to each other from entry surface end 431 to distal-end 432. Light reflects and exits crystal-phosphor rod 403 in a manner similar to crystal-phosphor rod 401 and crystal-phosphor rod 402.

FIGS. 4A, 4B, and 4C show several examples of the tapered crystal-phosphor rod of the present invention. FIG. 4A shows the rod being tapered in both axes from a larger rectangle to a smaller rectangle. FIG. 4B shows the rod being tapered to a single point. FIG. 4C shows another embodiment in which the tapering is only in one axis. In other embodiments, the taper angles of the two axes are different. In yet other embodiments, the cross-sections of the tapered crystal rod can be circular, elliptical, polygonal, etc. depending on the shape of the cross-sections required or desired.

FIG. 5 is a side-view cross-sectional block diagram of a laser-pumped crystal-phosphor system 501 having a one-dimensional or two-dimensional array 521 of tapered crystal-phosphor rods 520, according to some embodiments of the present invention. In some such embodiments (for example), a two-dimensional array 521 of sixteen (16) crystal-phosphor rods 520 is arranged as a 4×4 array, where FIG. 5 represents a cross-section through four of the sixteen crystal-phosphor rods 520, each of which is pumped by laser light 111 from one of a plurality of laser systems 110 (each of which includes one or more lasers). Continuing, FIG. 5 shows an embodiment in which a one- or two-dimensional array 521 of tapered crystal-phosphor rods 520 is used. The outputs from the plurality of tapered crystal-phosphor rods 520 are combined within the reflective waveguide 525 and exit as the output light 518 of the system 501. In some embodiments (not shown), a CPC such as shown in FIG. 3C is added to the right-hand end of waveguide 525. In some embodiments (not shown), each of the tapered phosphor rods 520 is replaced by a crystal rod, such as shown in FIGS. 3B and 3C, having a straight section 322 (wherein to top and bottom faces are parallel) added to the tapered section 321, and a heat-sink structure is provided in contact with the straight sections to extract heat.

FIG. 6 is a block diagram of a system 601 having one or more laser-pumped crystal-phosphor light sources 660, according to some embodiments of the present invention. In some embodiments, system 601 is a vehicle and the one or more laser-pumped crystal-phosphor light sources 660 provide headlight illumination for the vehicle. In other embodiments, system 601 is an entertainment projector and the one or more laser-pumped crystal-phosphor light sources 660 are used for projector(s) that are configured to output moving-light beam(s).

In some embodiments, the present invention provides an apparatus that includes: a first crystal-phosphor rod that includes an input-end face and an opposite end and a tapered section having one or more side surfaces of a tapered longitudinal cross section that is larger nearest the input-end face than at the opposite end.

In some embodiments, the first crystal-phosphor rod further includes a non-tapered section between the input-end face and the tapered section.

Some embodiments further include an internally reflective waveguide, wherein the first crystal-phosphor rod is located within the waveguide; and a heat sink surrounding at least a portion of the internally reflective waveguide, wherein the first crystal-phosphor rod further includes a non-tapered section between the input-end face and the tapered section, and wherein the non-tapered section is in thermal contact with the heat sink.

In some embodiments, the first crystal-phosphor rod has a rectangular transverse cross-sectional shape.

In some embodiments, the first crystal-phosphor rod has a rectangular transverse cross-sectional shape, wherein the first crystal-phosphor rod includes a phosphor that absorbs blue light and emits phosphor-emitted light having a wavelength longer than blue light, wherein the input-end face is coated with a wavelength-selective coating that passes a majority of blue light (e.g., light from a laser that emits blue and/or ultraviolet light having one or more wavelengths in a range from 300 to 500 nm, inclusive) and reflects a majority of the phosphor-emitted light. In some embodiments, one or more lasers other than semiconductor-diode lasers are used instead of, or in addition to, the described laser(s) of laser-excitation light source 110 in any of the embodiments shown or described herein, such as gas lasers, Nd:YAG lasers, chemical lasers and the like.

In some embodiments, the first crystal-phosphor rod has a rectangular transverse cross-sectional shape, wherein the first crystal-phosphor rod includes a phosphor that absorbs laser pump light having one or more wavelengths between 300 nm and 500 nm and emits phosphor-emitted light have one or more wavelengths longer than 500 nm, wherein the input-end face is coated with a wavelength-selective coating that passes a majority of the pump light and reflects a majority of the phosphor-emitted light.

Some embodiments further include an internally reflective waveguide, wherein the first crystal-phosphor rod is located within the waveguide; a heat sink surrounding at least a portion of the internally reflective waveguide, wherein the first crystal-phosphor rod further includes a non-tapered section between the input-end face and the tapered section, and wherein the non-tapered section is in thermal contact with the heat sink; a wavelength-selective filter located adjacent the input-end face of the first crystal-phosphor rod; and a laser system having at least one laser that emits pump light through the wavelength-selective filter into the first crystal-phosphor rod.

Some embodiments further include an internally reflective waveguide, wherein the first crystal-phosphor rod is located within the waveguide; a heat sink surrounding at least a portion of the internally reflective waveguide, wherein the first crystal-phosphor rod further includes a non-tapered section between the input-end face and the tapered section, and wherein the non-tapered section is in thermal contact with the heat sink; a compound parabolic concentrator (CPC) located to collect light from the waveguide and the first crystal-phosphor rod and to output a focused light beam; a wavelength-selective filter located adjacent the input-end face of the first crystal-phosphor rod; and a laser system having at least one laser that emits pump light through the wavelength-selective filter into the first crystal-phosphor rod.

Some embodiments further include an internally reflective waveguide, wherein the first crystal-phosphor rod is located within the waveguide; a heat sink surrounding at least a portion of the internally reflective waveguide, wherein the first crystal-phosphor rod further includes a non-tapered section between the input-end face and the tapered section, and wherein the non-tapered section is in thermal contact with the heat sink; a compound parabolic concentrator (CPC) located to collect light from the waveguide and the first crystal-phosphor rod and to output a focused light beam; a wavelength-selective filter located adjacent the input-end face of the first crystal-phosphor rod; a laser system having at least one laser that emits pump light through the wavelength-selective filter into the first crystal-phosphor rod; and a vehicle, wherein light from the focused light beam is used for headlight illumination for the vehicle.

Some embodiments further include an internally reflective waveguide, wherein the first crystal-phosphor rod is located within the waveguide; a heat sink surrounding at least a portion of the internally reflective waveguide, wherein the first crystal-phosphor rod further includes a non-tapered section between the input-end face and the tapered section, and wherein the non-tapered section is in thermal contact with the heat sink; a compound parabolic concentrator (CPC) located to collect light from the waveguide and the first crystal-phosphor rod and to output a focused light beam; a wavelength-selective filter located adjacent the input-end face of the first crystal-phosphor rod; a laser system having at least one laser that emits pump light through the wavelength-selective filter into the first crystal-phosphor rod; and projection optics for stage lighting, wherein light from the focused light beam is used for illumination for the stage lighting.

Some embodiments further include an internally reflective waveguide, wherein the first crystal-phosphor rod is located within the waveguide; at least one additional crystal-phosphor rod located within the waveguide; a wavelength-selective filter located adjacent the input-end face of the first crystal-phosphor rod and the at least one additional crystal-phosphor rod; a laser system having at least one laser that emits pump light through the wavelength-selective filter into the first crystal-phosphor rod the at least one additional crystal-phosphor rod located within the waveguide.

Some embodiments further include an internally reflective waveguide, wherein the first crystal-phosphor rod is located within the waveguide; a plurality of additional crystal-phosphor rods arranged in a two-dimensional array located within the waveguide; a wavelength-selective filter located adjacent the input-end face of the first crystal-phosphor rod and the plurality of additional crystal-phosphor rods; a laser system having at least one laser that emits pump light through the wavelength-selective filter into the first crystal-phosphor rod the plurality of additional crystal-phosphor rods located within the waveguide.

In some embodiments, the first crystal-phosphor rod has a circular transverse cross-sectional shape. In other embodiments, the first crystal-phosphor rod has an oval transverse cross-sectional shape. In yet other embodiments, the first crystal-phosphor rod has a curved transverse cross-sectional shape. In still, other embodiments, the first crystal-phosphor rod has a polygonal shape other than rectangular.

In some embodiments, the present invention provides a method that includes: receiving laser light into a first crystal-phosphor rod that includes an input-end face and an opposite end and a tapered section having one or more side surfaces of a tapered longitudinal cross section that is larger nearest the input-end face than at the opposite end; and collecting and concentrating phosphor-emitted light from the one or more side surfaces of the first crystal-phosphor rod into an output light beam.

In some embodiments of the method, the first crystal-phosphor rod further includes a non-tapered section between the input-end face and the tapered section, and the method further includes dissipating heat from a heat sink in thermal contact with non-tapered section.

In some embodiments of the method, the first crystal-phosphor rod further includes a non-tapered section between the input-end face and the tapered section, and the method further includes dissipating heat from a heat sink in thermal contact with non-tapered section, wherein the collecting and concentrating phosphor-emitted light includes using an internally reflecting waveguide and a compound parabolic concentrator (CPC) located to collect light from the waveguide and the first crystal-phosphor rod and outputting a focused light beam.

Some embodiments of the method further include receiving laser light into at least one additional crystal-phosphor rod that includes an input-end face and an opposite end and a tapered section having one or more side surfaces of a tapered longitudinal cross section that is larger nearest the input-end face than at the opposite end; and collecting and concentrating phosphor-emitted light from the one or more side surfaces of the first crystal-phosphor rod and the at least one additional crystal-phosphor rod into an output light beam.

In some embodiments, the present invention provides an apparatus that includes: a first crystal-phosphor rod that includes an input face, one or more side faces, and an opposite end; means for reflecting light in the first crystal-phosphor rod at increasingly steep angles to the one or more side faces such that light that reflects one or more times from total internal reflection exits the one or more side faces; means for receiving laser light into the input face of first crystal-phosphor rod; and means for collecting and concentrating phosphor-emitted light from the one or more side surfaces of the first crystal-phosphor rod into an output light beam. In some embodiments, the first crystal-phosphor rod further includes a non-tapered section between the input-end face and means for reflecting light in the first crystal-phosphor rod at increasingly steep angles to the one or more side faces, the apparatus further including means for dissipating heat from the non-tapered section.

It is to be understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. An apparatus comprising:
a first crystal-phosphor rod that includes an input-end face and an opposite end and a tapered section having one or more side surfaces of a tapered longitudinal cross section that is larger nearest the input-end face than at the opposite end.

2. The apparatus of claim 1, wherein the first crystal-phosphor rod further includes a non-tapered section between the input-end face and the tapered section.

3. The apparatus of claim 1, further comprising:
an internally reflective waveguide, wherein the first crystal-phosphor rod is located within the waveguide; and
a heat sink surrounding at least a portion of the internally reflective waveguide, wherein the first crystal-phosphor rod further includes a non-tapered section between the input-end face and the tapered section, and wherein the non-tapered section is in thermal contact with the heat sink.

4. The apparatus of claim 1, wherein the first crystal-phosphor rod has a rectangular transverse cross-sectional shape.

5. The apparatus of claim 1, wherein the first crystal-phosphor rod has a rectangular transverse cross-sectional shape, wherein the first crystal-phosphor rod includes a phosphor that absorbs blue light and emits phosphor-emitted light having a wavelength longer than blue light, wherein the input-end face is coated with a wavelength-selective coating that passes a majority of blue light and reflects a majority of the phosphor-emitted light.

6. The apparatus of claim 1, wherein the first crystal-phosphor rod has a rectangular transverse cross-sectional shape, wherein the first crystal-phosphor rod includes a phosphor that absorbs laser pump light having one or more wavelengths between 300 nm and 500 nm and emits phosphor-emitted light have one or more wavelengths longer than 500 nm, wherein the input-end face is coated with a wavelength-selective coating that passes a majority of the pump light and reflects a majority of the phosphor-emitted light.

7. The apparatus of claim 1, further comprising:
an internally reflective waveguide, wherein the first crystal-phosphor rod is located within the waveguide;
a heat sink surrounding at least a portion of the internally reflective waveguide, wherein the first crystal-phosphor rod further includes a non-tapered section between the input-end face and the tapered section, and wherein the non-tapered section is in thermal contact with the heat sink;
a wavelength-selective filter located adjacent the input-end face of the first crystal-phosphor rod; and
a laser system having at least one laser that emits pump light through the wavelength-selective filter into the first crystal-phosphor rod.

8. The apparatus of claim 1, further comprising:
an internally reflective waveguide, wherein the first crystal-phosphor rod is located within the waveguide;
a heat sink surrounding at least a portion of the internally reflective waveguide, wherein the first crystal-phosphor rod further includes a non-tapered section between the input-end face and the tapered section, and wherein the non-tapered section is in thermal contact with the heat sink;
a compound parabolic concentrator (CPC) located to collect light from the waveguide and the first crystal-phosphor rod and to output a focused light beam;
a wavelength-selective filter located adjacent the input-end face of the first crystal-phosphor rod; and
a laser system having at least one laser that emits pump light through the wavelength-selective filter into the first crystal-phosphor rod.

9. The apparatus of claim 1, further comprising:
an internally reflective waveguide, wherein the first crystal-phosphor rod is located within the waveguide;
a heat sink surrounding at least a portion of the internally reflective waveguide, wherein the first crystal-phosphor rod further includes a non-tapered section between the input-end face and the tapered section, and wherein the non-tapered section is in thermal contact with the heat sink;
a compound parabolic concentrator (CPC) located to collect light from the waveguide and the first crystal-phosphor rod and to output a focused light beam;
a wavelength-selective filter located adjacent the input-end face of the first crystal-phosphor rod;
a laser system having at least one laser that emits pump light through the wavelength-selective filter into the first crystal-phosphor rod; and
a vehicle, wherein light from the focused light beam is used for headlight illumination for the vehicle.

10. The apparatus of claim 1, further comprising:
an internally reflective waveguide, wherein the first crystal-phosphor rod is located within the waveguide;
a heat sink surrounding at least a portion of the internally reflective waveguide, wherein the first crystal-phosphor rod further includes a non-tapered section between the input-end face and the tapered section, and wherein the non-tapered section is in thermal contact with the heat sink;
a compound parabolic concentrator (CPC) located to collect light from the waveguide and the first crystal-phosphor rod and to output a focused light beam;
a wavelength-selective filter located adjacent the input-end face of the first crystal-phosphor rod;
a laser system having at least one laser that emits pump light through the wavelength-selective filter into the first crystal-phosphor rod; and
projection optics for stage lighting, wherein light from the focused light beam is used for illumination for the stage lighting.

11. The apparatus of claim 1, further comprising:
an internally reflective waveguide, wherein the first crystal-phosphor rod is located within the waveguide;
at least one additional crystal-phosphor rod located within the waveguide;
a wavelength-selective filter located adjacent the input-end face of the first crystal-phosphor rod and the at least one additional crystal-phosphor rod; and
a laser system having at least one laser that emits pump light through the wavelength-selective filter into the first crystal-phosphor rod the at least one additional crystal-phosphor rod located within the waveguide.

12. The apparatus of claim 1, further comprising:
an internally reflective waveguide, wherein the first crystal-phosphor rod is located within the waveguide;
a plurality of additional crystal-phosphor rods arranged in a two-dimensional array located within the waveguide;
a wavelength-selective filter located adjacent the input-end face of the first crystal-phosphor rod and the plurality of additional crystal-phosphor rods; and
a laser system having at least one laser that emits pump light through the wavelength-selective filter into the first crystal-phosphor rod the plurality of additional crystal-phosphor rods located within the waveguide.

13. The apparatus of claim 1, wherein the first crystal-phosphor rod has a circular transverse cross-sectional shape.

14. The apparatus of claim 1, wherein the first crystal-phosphor rod has a curved transverse cross-sectional shape.

15. A method comprising:
receiving laser light into a first crystal-phosphor rod that includes an input-end face and an opposite end and a tapered section having one or more side surfaces of a tapered longitudinal cross section that is larger nearest the input-end face than at the opposite end; and
collecting and concentrating phosphor-emitted light from the one or more side surfaces of the first crystal-phosphor rod into an output light beam.

16. The method of claim 15, wherein the first crystal-phosphor rod further includes a non-tapered section between the input-end face and the tapered section, the method further including:
dissipating heat from a heat sink in thermal contact with non-tapered section.

17. The method of claim 15, wherein the first crystal-phosphor rod further includes a non-tapered section between the input-end face and the tapered section, the method further including:
dissipating heat from a heat sink in thermal contact with non-tapered section; and
wherein the collecting and concentrating phosphor-emitted light includes using an internally reflecting waveguide and a compound parabolic concentrator (CPC) located to collect light from the waveguide and the first crystal-phosphor rod and outputting a focused light beam.

18. The method of claim 15, further comprising:
receiving laser light into at least one additional crystal-phosphor rod that includes an input-end face and an opposite end and a tapered section having one or more side surfaces of a tapered longitudinal cross section that is larger nearest the input-end face than at the opposite end; and
collecting and concentrating phosphor-emitted light from the one or more side surfaces of the first crystal-phosphor rod and the at least one additional crystal-phosphor rod into an output light beam.

19. An apparatus comprising:
a first crystal-phosphor rod having an input face, one or more side faces, and an opposite end;
means for reflecting light in the first crystal-phosphor rod at increasingly steep angles to the one or more side faces such that light that reflects one or more times from total internal reflection exits the one or more side faces;
means for receiving laser light into the input face of first crystal-phosphor rod; and
means for collecting and concentrating phosphor-emitted light from the one or more side surfaces of the first crystal-phosphor rod into an output light beam.

20. The apparatus of claim 19, wherein the first crystal-phosphor rod further includes a non-tapered section between the input-end face and the tapered section, further comprising:
means for dissipating heat from the non-tapered section.
